(19) United States
(12) Patent Application Publication
(10) Pub. No.: US 2021/0256573 A1
(43) Pub. Date: Aug. 19, 2021

(54) METHOD AND SYSTEM FOR RECEIVING REAL-TIME PROVISIONAL VEHICLE AUCTION BIDS

(71) Applicant: 1-Click Auto Auction, LLC, Austin, TX (US)

(72) Inventors: Mark Elliot Gibson, Austin, TX (US); Leslie Brian Bruce, Lubbock, TX (US)

(73) Assignee: 1-Click Auto Auction, LLC, Austin, TX (US)

(21) Appl. No.: 17/179,021

(22) Filed: Feb. 18, 2021

Related U.S. Application Data
(60) Provisional application No. 62/978,549, filed on Feb. 19, 2020.

(51) Int. Cl. G06Q 30/02; G06Q 30/08; G06K 9/32

(52) U.S. Cl. CPC G06Q 30/0278; G06K 9/325; G06Q 30/08

(57) ABSTRACT

Methods, systems, and storage media for operating a real-time vehicle valuation platform are disclosed. Exemplary implementations may: capture an image of a vehicle identification number “VIN” of a vehicle; use the VIN to access original vehicle information of the vehicle; receive current condition information of the vehicle; create a vehicle profile including the VIN, original vehicle information, and current condition information; transmit the vehicle profile to a provisional auction platform; and receive at least one provisional bid for purchase of the vehicle.

### CROSS-REFERENCE TO RELATED APPLICATIONS

This application claims priority to and the benefit of U.S. Prov. Pat. App. 62/978,549, filed Feb. 19, 2020, and titled “Method and System for Receiving Real-Time Provisional Vehicle Auction Bids”. The content of this provisional application is incorporated herein by reference in its entirety.

### TECHNICAL FIELD

This disclosure relates generally to technological improvements in the fields of automotive appraisal and resale. More specifically, the disclosure describes systems and methods for operating a real-time vehicle valuation platform including an auction feature that promptly provides an accurate valuation of a used vehicle.

### BACKGROUND

Many automobile dealerships rely on profits made from the resale of used vehicles as an important portion of their revenue. Even where such revenue may not be significant for a particular dealership, dealerships must be able to offer competitive trade-in values in order to attract customers and close deals on new automobiles.

Conventionally, a trade-in value offer on a used automobile is set and offered largely based on a sales manager, wholesaler, or dealer's subjective experience. This experience may in some cases be supplemented by vehicle value data aggregators for which the quality and breadth of coverage may vary. The contemporaneousness of the data available to such aggregators may also vary dramatically. Such dealership valuations and subsequent offers are also typically limited by factors particular to the local market where the dealership is located.

### SUMMARY

In general, the present disclosure provides an improved real-time vehicle valuation platform that promptly provides an accurate and reliable valuation of a used vehicle. One aspect of the present invention relates to a method for operating a vehicle valuation platform configured to receive information about a vehicle to be valued; create a vehicle profile including the vehicle's vehicle identification number (“VIN”), original vehicle attributes, and current vehicle condition information; and receive a provisional bid for purchase of the vehicle.

The system may include one or more hardware processors configured by machine-readable instructions stored in a memory. The processor(s) may be configured to receive, from a VIN scanning device, a digital representation of the VIN of a vehicle. The processor(s) may be configured to access, at least in part using the VIN of the vehicle, original vehicle information associated with the vehicle. The processor(s) may be configured to receive condition information associated with the vehicle. The processor(s) may be configured to create a vehicle profile comprising the vehicle's VIN, at least a portion of the original information associated with the vehicle, and at least a portion of the condition information associated with the vehicle. The processor(s) may be configured to transmit the vehicle profile to a provisional auction platform and receive, from the provisional auction platform, at least one provisional bid for purchase of the vehicle.

In some implementations of the system, the VIN scanning device may comprise a smartphone executing a mobile application programmed for capturing an image of a vehicle's VIN and generating the digital representation of the vehicle's VIN.

In some implementations of the system, the processor(s) may be further configured to transmit an auction notification to a plurality of vehicle dealers. While “deales” are typically referred to throughout this specification, it should be understood that any reference to a dealer herein may apply equivalently to a wholesaler. In some implementations of the system, at least one of the provisional bids may be binding on the bidder for a period of time.

In some implementations of the system, the original vehicle information associated with the vehicle comprises information listed on the original window sales sticker of the vehicle (sometimes referred to a “Monroney sticker”). In some implementations of the system, the condition information associated with the vehicle comprises one or more recent photographs of the vehicle. In some implementations of the system, the condition information associated with the vehicle comprises a condition rating of the vehicle. In some implementations of the system, the condition information associated with the vehicle comprises an odometer value of the vehicle.

Another aspect of the present disclosure relates to a method for operating a vehicle valuation platform. The method may include capturing an image of a vehicle identification number (“VIN”) of a vehicle. The method may include accessing, at least in part using the VIN of the vehicle, original vehicle information associated with the vehicle. The method may include receiving current condition information associated with the vehicle.

The method may include creating a vehicle profile, the vehicle profile comprising the vehicle's VIN, at least a portion of the original information associated with the vehicle, and at least a portion of the condition information associated with the vehicle.

The method may include transmitting the vehicle profile to a provisional auction platform. The method may include receiving, from the provisional auction platform, at least one provisional bid for purchase of the vehicle.

In some implementations of the method, at least one of the provisional bids may be binding on a winning auction bidder, either permanently or for a period of time. In some implementations of the method, the original vehicle information associated with the vehicle comprises information listed on the original window sales sticker of the vehicle—for example, the original pricing, vehicle options, and any other information that would have been listed on an original window sticker.

In some implementations of the method, the provisional auction platform may, at least in part, collect and/or aggregate estimates of the value of the vehicle received from a plurality of third-party vehicle valuation platforms. According to various embodiments, the provisional auction platform may utilize one or more application programming interfaces (“APIs”) of third-party vehicle valuation platforms, including reformatting the submitted data according to the requirements of various APIs.

Some implementations of the method may further include transmitting the vehicle profile to a plurality of vehicle valuation platforms. Some implementations of the method may further include receiving, from the plurality of vehicle valuation platforms, a plurality of estimated values of the vehicle. Some implementations of the method may further include calculating an aggregated estimated value for the vehicle at least in part by aggregating the received plurality of estimated values of the vehicle.

Some implementations of the method may further include transmitting an auction notification to a plurality of vehicle dealers.

In some implementations of the method, the condition information associated with the vehicle comprises one or more recent photographs of the vehicle. In some implementations of the method, the condition information associated with the vehicle comprises a condition rating of the vehicle. In some implementations of the method, the condition information associated with the vehicle includes an odometer value of the vehicle.

Yet another aspect of the present invention relates to a non-transient computer-readable storage medium having instructions stored thereon, the instructions being executable by the one or more processors to perform a method for operating a vehicle valuation platform. The method may include capturing an image of a vehicle identification number “VIN” of a vehicle. The method may include accessing, at least in part using the VIN of the vehicle, original vehicle information associated with the vehicle. The method may include receiving subjective and/or objective condition information associated with the vehicle, including subjective condition ratings as well as objective information such as odometer reading data.

The method may include creating a vehicle profile, the vehicle profile comprising the vehicle's VIN, at least a portion of the original information associated with the vehicle, and at least a portion of the condition information associated with the vehicle.

The method may include transmitting the vehicle profile to a provisional auction platform. The method may include receiving, from the provisional auction platform, at least one provisional bid for purchase of the vehicle.

According to some embodiments, the original vehicle information associated with the vehicle may comprise information listed on the original window sales sticker of the vehicle—for example, the original pricing, vehicle options, and any other information that would have been listed on an original window sticker.

According to some embodiments, the instructions may further cause the computing system to transmit the vehicle profile to a plurality of vehicle valuation platforms. According to some embodiments, the instructions may further cause the computing system to receive, from the plurality of vehicle valuation platforms, a plurality of estimated values of the vehicle. According to some embodiments, the instructions may further cause the computing system to calculate an aggregated estimated value for the vehicle at least in part by aggregating the received plurality of estimated values of the vehicle.

Throughout this specification, references to “real-time” should be understood to include “near-time” and any time reasonably proximate with respect to the request for vehicle valuation.

Other technical features may be readily apparent to one skilled in the art from the following figures, descriptions, and claims. These and other features, and attributes of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system architecture, according to some embodiments of this disclosure.

FIG. 2 illustrates details of a vehicle profile according to various embodiments.

FIG. 3 illustrates details of a notification profile according to various embodiments.

FIG. 4 represents a flowchart for a method of operating a real-time vehicle valuation platform according to some embodiments of the disclosure.

FIG. 5 represents a flowchart for an additional method of operating a real-time vehicle valuation platform according to some embodiments of the disclosure.

FIG. 6 represents a flowchart for an example workflow of a dealership salesperson according to some embodiments of the disclosure.

FIG. 7 represents a flowchart for an example workflow of a dealership sales manager according to some embodiments of the disclosure.

FIG. 8 represents a flowchart for an example workflow of a vehicle dealer according to some embodiments of the disclosure.

FIG. 9 represents a flowchart for an example workflow on a dealer notification function according to some embodiments of the disclosure.

### DETAILED DESCRIPTION

Improvement is desired in the quality and timeliness of used vehicle valuations. In particular, improvement is desired in the accuracy and timeliness of vehicle valuation available to automobile dealerships with respect to prospective used trade-in vehicles. By leveraging modern technological hardware and methods to solicit real-time bids on prospective trade-in vehicles, automobile dealerships can increase their efficiency and profits.

Aspects of the present disclosure relate to embodiments that overcome the deficiencies of conventional vehicle valuation methods described herein. The present disclosure relates to operating a real-time vehicle valuation platform, in part by providing a provisional auction platform. Throughout this disclosure, references to “f” valuation information should be understood to include information received promptly and relatively contemporaneously with the proposed vehicle transactions, but shall not be construed to strictly require an immediate response.

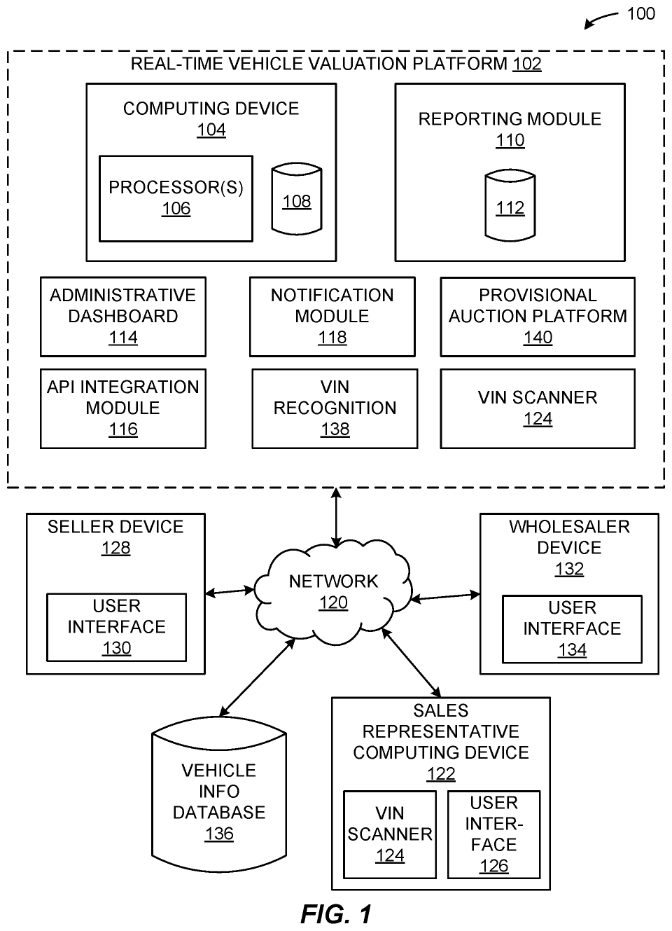

FIGS. 1 through 9, discussed below, and the various embodiments used to describe the principles of this disclosure are by way of illustration only and should not be construed in any way to limit the scope of the disclosure.

FIG. 1 illustrates a high-level component diagram of an illustrative system architecture, according to some embodiments of this disclosure.

The example architecture 100 includes a network 120 that communicatively couples various devices, including the real-time vehicle valuation platform 102, sales representative computing device 122, sales manager device 128, dealer device 132, and vehicle information database 136. The network 120 can include local area networks (LANs) and wide area networks (WANs). The network 102 can include wired technologies (e.g., Ethernet®) and wireless technologies (e.g., Wi-Fi®, code division multiple access (CDMA), near-field communication (“NFC”), global system for mobile (GSM), universal mobile telephone service (UMTS), Bluetooth®, and ZigBee®. For example, real-time vehicle valuation platform 102 can use a wired connection or a wireless technology (e.g., Wi-Fi®) to transmit and receive data over the network 120.

In an exemplary operation, real-time vehicle valuation platform 102 may be configured to facilitate various operations including capturing an image of a vehicle identification number “VIN” of a vehicle for which a valuation is sought. In some embodiments, real-time vehicle valuation platform 102 may receive an image of a VIN of a vehicle for which a valuation is sought, for example from a VIN scanner 124 of sales representative computing device 122. According to some embodiments, VIN scanner 124 may represent a combination of hardware and software located within device 122, platform 102, or a combination of both. According to some embodiments, VIN recognition module 138 may be configured to decode an image of a VIN number by using known optical character recognition or other methods, for example those commonly employed in license plate reader technology. In other embodiments, VIN scanner 124 or another application running at sales representative computing device 122 may be responsible for decoding a VIN image to produce a string representing the vehicle's VIN.

According to some embodiments, real-time vehicle valuation platform 102 may be further configured to access original vehicle information associated with the vehicle. For example, information of the original window sales sticker (or “Monroney sticker”) of the vehicle may include VIN, the manufacturer's suggested retail price (“MSRP”), the vehicle's options and color, and other information relevant to the original condition of the car at the time it was new, as may be apparent to one having ordinary skill in the art. According to some embodiments, real-time vehicle valuation platform 102 may original vehicle information via vehicle information database 136 or another database or information system that contains the appropriate information.

According to some embodiments of the invention, real-time vehicle valuation platform 102 may receive current condition information of the vehicle. For example, real-time vehicle valuation platform 102 may receive an odometer reading of the mileage of the vehicle and/or a condition rating of the vehicle. According to some embodiments, a condition rating of the vehicle may be a numerical rating (e.g. 1 to 5) or a text description (e.g. “poor,” “fair,” “good,” “excellent”). According to some embodiments, current condition information may include one or more recent photographs as well as other relevant current condition information as would be apparent to one having ordinary skill in the art.

According to some embodiments, real-time vehicle valuation platform 102 may create a vehicle profile combining the vehicle's VIN, at least a portion of the original information associated with the vehicle, at least a portion of the condition information associated with the vehicle, and other appropriate information as would be apparent to one having ordinary skill in the art.

According to some embodiments, real-time vehicle valuation platform 102 may transmit the vehicle profile to a provisional auction platform such as provisional auction platform 140. According to some embodiments, provisional auction platform 140 provides an opportunity to a plurality of vehicle dealers to provide bids on the vehicle based on the vehicle profile, as described in further detail herein.

According to some embodiments, notification module 118 of real-time vehicle valuation platform 102 may generate notifications to dealers, for example via one or more dealer devices 132, when a vehicle profile has been made available when an auction has started or is about to start. According to some embodiments, an auction may be for a set period of time. In other embodiments, an auction may remain open until a firm bid is received. In some embodiments, an auction may be scheduled to last 15 minutes so that a reliable vehicle value and/or firm bid may be sent back to the requesting dealership while a potential customer is still on the dealership premises.

According to some embodiments, dealers may set notification preferences or filters and request to be notified when vehicles matching the dealer's filters become available. According to some embodiments, dealers or other users may set notification filters by make and model of vehicle, one or more model year ranges, a vehicle mileage range, a vehicle transmission type, one or more vehicle colors, one or more vehicle body styles (e.g. sedan, coupe, convertible, etc.), condition ratings, title status, and other appropriate vehicle attributes as would be apparent to one having ordinary skill in the art. According to some embodiments, various types of notifications may be requested—for example, SMS/mobile message, email, smartphone push notifications, and any other appropriate notifications as would be apparent to one having ordinary skill in the art.

According to some embodiments, real-time vehicle valuation platform 102 may receive, from the provisional auction platform, one or more provisional bids for purchase of the vehicle. According to some embodiments, real-time vehicle valuation platform 102 may then transmit the winning bid back to a requesting dealership. In the case on a binding auction, the winning bid may be binding on the winner permanently or for a defined period of time.

Real-time vehicle valuation platform 102, according to some embodiments, may include a computing device 104 having one or more processors 106 for executing the tasks of real-time vehicle valuation platform 102 and a computing database 108. Computing device 104 may be any suitable computing device such as a computer server, laptop, tablet, smartphone, or desktop or laptop computer. The one or more processors 106 may be configured to execute computer instructions stored on a computing device 104 or elsewhere in real-time vehicle valuation platform 102. Database 108 of computing device 104 may store any data necessary to enable the operation of real-time vehicle valuation platform 102. For example, database 108 may include vehicle profiles, dealer notification filters, information of valuation services, etc.

According to some embodiments of the invention, real-time vehicle valuation platform 102 may further transmit the vehicle to a plurality of vehicle valuation platforms, such as web-based services that aggregate data and attempt to provide market values for various particular types and conditions of vehicles. According to some embodiments, real-time vehicle valuation platform 102 may receive, from the plurality of vehicle valuation platforms, a plurality of estimated values for the vehicle. According to some embodiments, at least some of the plurality of estimated values for the vehicle may be displayed separately. According to some embodiments, real-time vehicle valuation platform 102 may then aggregate the plurality of estimated values to calculate an aggregated estimated value for the vehicle.

According to some embodiments, API integration module 116 may facilitate communication between real-time vehicle valuation platform 102 and the plurality of vehicle valuation platforms. For example, API integration module may facilitate formatting of vehicle profiles and data requests according to the particular specifications of various ones of the plurality of vehicle valuation platforms.

According to some embodiments, a reporting module 110 of real-time vehicle valuation platform 102 may prepare and provide various reports and analyses of activities of real-time vehicle valuation platform 102, salespersons, sales managers, or dealers. As one example, a sales manager may access the reporting module 110 to find reports on types of vehicles processed by real-time vehicle valuation platform 102, values of those vehicles, potential or actual customer names, whether or not a deal was completed, and any other appropriate information as would be apparent to one having ordinary skill in the art. According to some embodiments, reports may be stored in database 112 of reporting module 110.

According to some embodiments, real-time vehicle valuation platform 102 may provide an administrative dashboard 114. According to some embodiments, users of real-time vehicle valuation platform 102 who have administrative privileges may use the administrative dashboard to perform various operations including adding and removing users, reviewing and removing content, reviewing data, sending messages to individual users or groups of users, or other appropriate functions as would be apparent to one having ordinary skill in the art.

According to some embodiments, sales representative computing device 122 facilitates communication between a dealership salesperson or sales representative and real-time vehicle valuation platform 102. Sales representative computing device 122 may be any suitable computing device, such as a smartphone, tablet, or desktop or laptop computer. Sales representative computing device 122 may include a user interface 126 for presenting information and/or receiving inputs from a user of sales representative computing device 122. Sales representative computing device 122 may additionally include a VIN scanner 124. According to some embodiments, VIN scanner 124 may be an application running on sales representative computing device 122. For example, VIN scanner 124 may use a camera of sales representative computing device 122 to take a photograph of the VIN of a vehicle. In other embodiments, VIN scanner 124 may be an application resident on a computing device 104 of any suitable computing device, such as a smartphone, tablet, or desktop or laptop computer.

According to some embodiments, sales manager device 128 facilitates communication between a dealership sales manager and real-time vehicle valuation platform 102. Sales manager device 128 may be any suitable computing device, such as a smartphone, tablet, or desktop or laptop computer. Sales manager device 128 may include a user interface 130 for presenting information and receiving input or feedback from a user of sales manager device 128.

According to some embodiments, dealer device 132 facilitates communication between a vehicle dealer and real-time vehicle valuation platform 102. Dealer device 132 may be any suitable computing device, such as a smartphone, tablet, or desktop or laptop computer. Dealer device 132 may include a user interface 134 for presenting information and receiving input or feedback from user of dealer device 132.

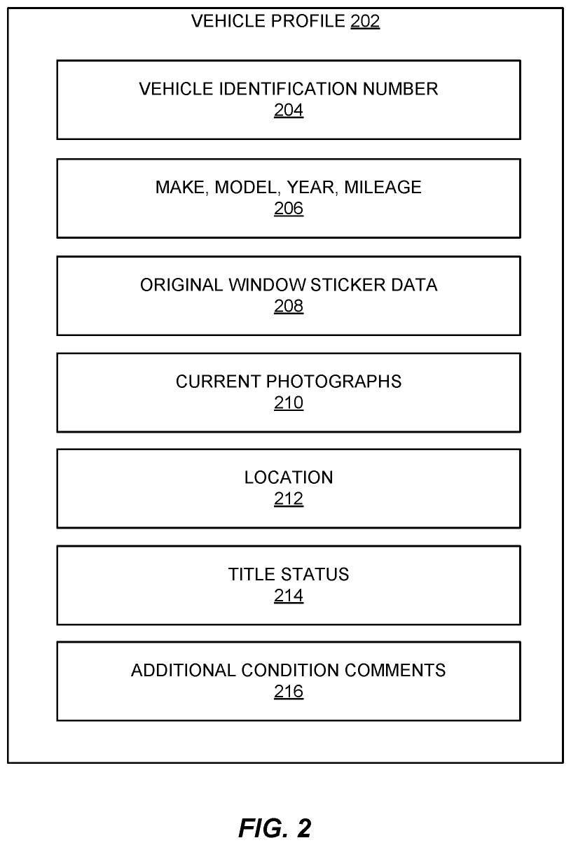

FIG. 2 illustrates details of a vehicle profile according to various embodiments. Vehicle profile 202 according to some embodiments represents the combined information of a vehicle for which a valuation is being requested. For example, vehicle profile 202 may include the vehicle's VIN, at least a portion of the original information associated with the vehicle, at least a portion of the condition information associated with the vehicle, and other appropriate information as would be apparent to one having ordinary skill in the art.

Vehicle identification number (“VIN”) 204 of vehicle profile 202, according to some embodiments, represents the unique identification number assigned to all new vehicles and typically placed in various specific areas on a vehicle for identification purposes. For example, a conventional VIN is a 17-character combination of letters and numbers. However, older VINs or future VIN or equivalent systems may include a different number of characters or formatting.

Make, model, year, mileage 206 of vehicle profile 202, according to some embodiments, represents the manufacturer (“make”), model name, model year or year of manufacture, and mileage (odometer reading) of the vehicle. According to some embodiments, the odometer reading may be entered manually.

Original window sticker data 208 (also called a “Monroney sticker”) of vehicle profile 202 may be included as information decoded using the VIN. For example, information of the original window sales sticker of the vehicle may include VIN, the manufacturer's suggested retail price (“MSRP”), the vehicle's options and color, and other information relevant to the original condition of the car at the time it was new, as may be apparent to one having ordinary skill in the art. In some embodiments, only a portion of the original window sticker information may be available using a VIN decoding/lookup technique.

Current photographs 210 of vehicle profile 202, according to some embodiments, may include visual representations of a current condition of the vehicle. For example, a sales representative may take one or more photographs of the vehicle during intake and in preparation of the valuation request. According to some embodiments, a minimum number and type of photographs that must be submitted may be established. For example, a system may require at least five photographs, representing front, rear, left side, right side, and odometer of the vehicle.

Location 212 of vehicle profile 202, according to some embodiments, may include the geographical location of the vehicle itself and/or the location of the dealership requesting valuation.

Title status 214 of vehicle profile 202, according to some embodiments, may include the current status of the vehicle's title (e.g. “in hand,” “bank loan,” “salvage,” etc.). According to some embodiments, additional condition comments 216 may include additional information not already presented about the condition of the vehicle or circumstances of the proposed sale or trade-in. According to some embodiments, additional condition comments may be entered by a sales representative or sales manager of a dealership requesting valuation.

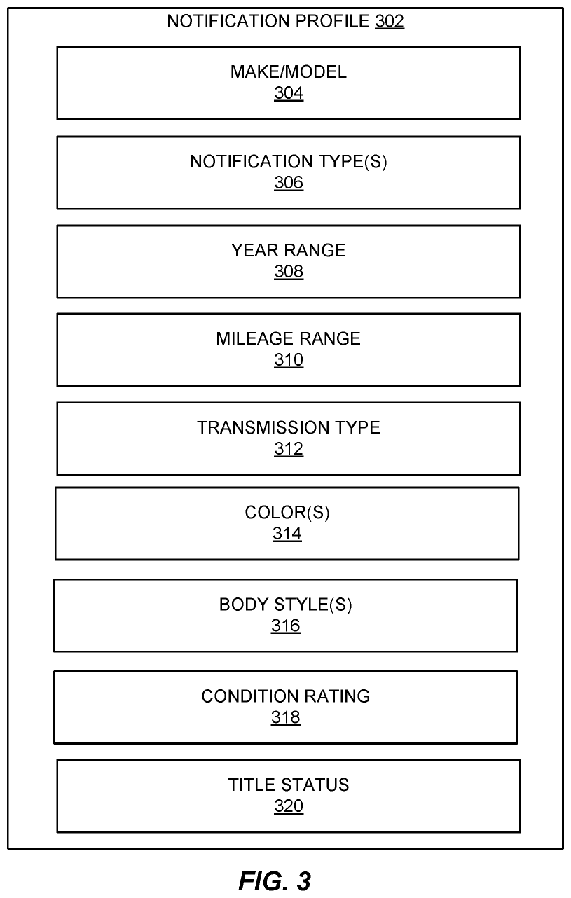

FIG. 3 illustrates details of a notification profile according to various embodiments. Notification profile 302, according to some embodiments, may include preferences or filters intended to trigger notifications when a vehicle profile such as a vehicle profile 202 is requested for valuation or auction. According to some embodiments, a notification profile 302 may be created in response to filters set by a vehicle dealer.

Make/model 304, according to some embodiments, may refer to the manufacturer and model name of a vehicle.

Notification type(s) 306 of notification profile 302 may include requests for specific types of notifications to be generated in response to a matching vehicle profile. For example, notification type(s) 306 may include SMS/mobile message, email, smartphone push notifications, and any other types of notification as may be apparent to one having ordinary skill in the art.

According to some embodiments, a year range 308 of notification profile 302 may include the model year(s) and or year(s) of manufacture requested according to preferences or filters set. A mileage range 310, according to some embodiments, may include a range of acceptable odometer readings and/or a maximum or minimum mileage reading according to preferences or filters set.

A transmission type 312 of notification profile 302, according to some embodiments, may specify the type of transmission in the vehicle—for example, manual, automatic, continuously variable transmission, etc.

According to some embodiments, one or more color(s) 314 may be specified by preference requests or filters. Color information may include exterior and/or interior colors according to various embodiments. Body style(s) 316, according to various embodiments, may refer to the vehicle body style—for example, sedan, convertible, coupe, pickup truck, minivan, etc.

A condition rating 318 of notification profile 302, according to some embodiments, a condition rating of the vehicle may be a numerical rating (e.g. 1 to 5) or a text description (e.g. “poor,” “fair,” “good,” “excellent”) of the current vehicle's condition.

A title status 320 of notification profile 302, according to some embodiments, may include the current status of the vehicle's title (e.g. “in hand,” “bank loan,” “salvage,” etc.).

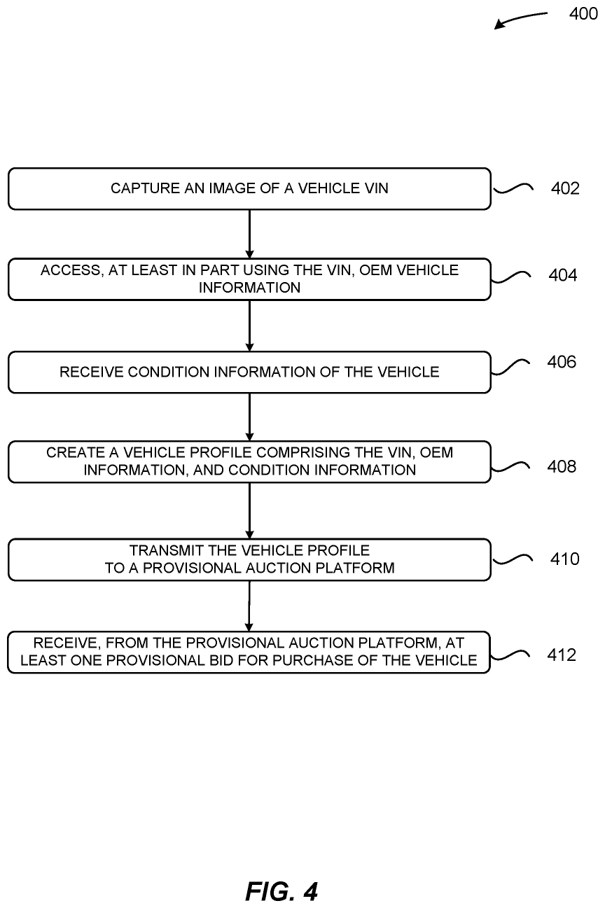

FIG. 4 represents a flowchart for a method of operating a real-time vehicle valuation platform according to some embodiments of the disclosure. According to some embodiments, some or all of the steps of flowchart 400 may be carried out by a system like system 100 as described with reference to FIG. 1.

At step 402, an image of a vehicle VIN is captured. According to some embodiments, the image may be captured, for example, by a camera of mobile device operated by a dealership sales representative. According to some embodiments, a VIN scanner application may facilitate capturing a VIN image.

At step 404, according to some embodiments, original (or original equipment manufacturer (“OEM”) information is accessed, at least in part using the vehicle VIN. For example, the original pricing, vehicle options, and any other information that would have been listed on an original window sticker may be included in the original information.

At step 406, current condition information of the vehicle is received. For example condition information collected at step 406 may include an odometer reading, photographs of the vehicle, a condition rating, and other appropriate condition information as would be apparent to a person having ordinary skill in the art.

At step 408, a vehicle profile is created, the vehicle profile including the VIN, at least a portion of the original vehicle information, at least a portion of the current condition information, and other appropriate information as would be apparent to one having ordinary skill in the art.

At step 410, the vehicle profile may be transmitted to a provisional auction platform. For example, the provisional auction platform may provide vehicle dealers and other interested parties with an opportunity to bid on a particular vehicle represented by the vehicle profile.

At step 412, at least one provisional bid is received through the provisional auction platform. In some embodiments, a provisional bid may be binding on the bidding party permanently or temporarily.

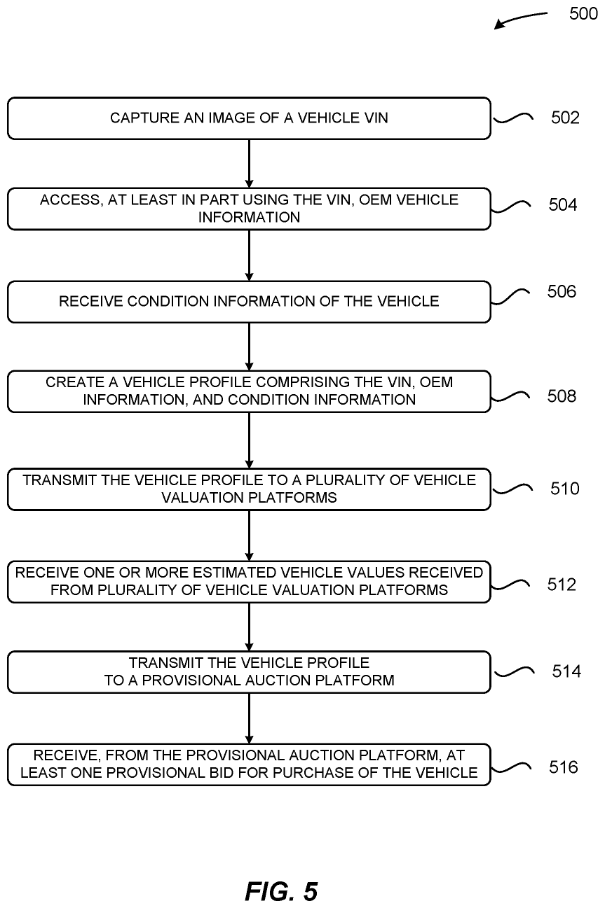

FIG. 5 represents a flowchart for an additional method of operating a real-time vehicle valuation platform according to some embodiments of the disclosure. According to some embodiments, some or all of the steps of flowchart 500 may be carried out by a system like system 100 as described with reference to FIG. 1.

At step 502, an image of a vehicle VIN is captured. According to some embodiments, the image may be captured, for example, by a camera of mobile device operated by a dealership sales representative. According to some embodiments, a VIN scanner application may facilitate capturing a VIN image.

At step 504, according to some embodiments, original (or original equipment manufacturer (“OEM”) information is accessed, at least in part using the vehicle VIN. For example, the original pricing, vehicle options, and any other information that would have been listed on an original window sticker may be included in the original information.

At step 506, current condition information of the vehicle is received. For example condition information collected at step 406 may include an odometer reading, photographs of the vehicle, a condition rating, and other appropriate condition information as would be apparent to a person having ordinary skill in the art.

At step 508, a vehicle profile is created, the vehicle profile including the VIN, at least a portion of the original vehicle information, at least a portion of the current condition information, and other appropriate information as would be apparent to one having ordinary skill in the art.

At step 510, according to some embodiments, the vehicle profile may be transmitted to a plurality of vehicle valuation platforms, such as web-based services that aggregate data and attempt to provide market values for various particular types and conditions of vehicles.

At step 512, according to some embodiments, a plurality of estimated values of the vehicle may be received from the plurality of vehicle valuation platforms. According to some embodiments, the plurality of estimated values may be aggregated to calculate an aggregated estimated value for the vehicle.

At step 514, the vehicle profile may be transmitted to a provisional auction platform. For example, the provisional auction platform may provide vehicle dealers and other interested parties with an opportunity to bid on a particular vehicle represented by the vehicle profile.

At step 516, at least one provisional bid is received through the provisional auction platform. In some embodiments, a provisional bid may be binding on the bidding party permanently or temporarily.

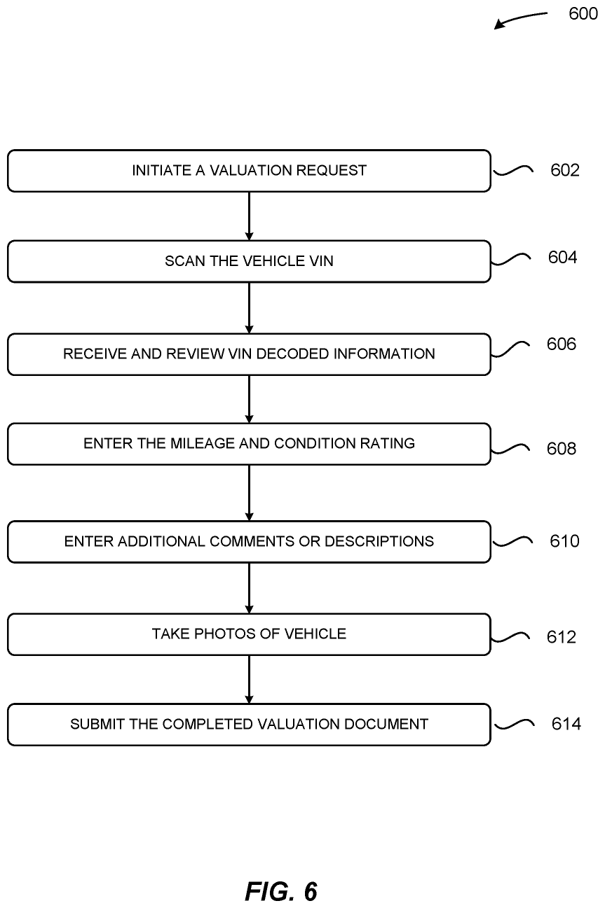

FIG. 6 represents a flowchart for an example workflow of a dealership salesperson according to some embodiments of the disclosure. According to some embodiments, some or all of the steps of flowchart 600 may be carried out by a system like system 100 as described with reference to FIG. 1.

At step 602, a dealership sales representative or salesperson may initiate a vehicle valuation request, for example to value a potential trade-in vehicle as part of a prospective new automobile sale. According to some embodiments, a customer name or other appropriate information may be entered to initiate a valuation request.

At step 604, a vehicle VIN may be scanned, for example by a scanner application running on a mobile device operated by a dealership sales representative. According to some embodiments, an image of the VIN may be captured, for example, by a camera of mobile device operated by a dealership sales representative.

At step 606, according to some embodiments, original (or original equipment manufacturer (“OEM”) information is accessed, at least in part using the vehicle VIN. For example, the original pricing, vehicle options, and any other information that would have been listed on an original window sticker may be included in the original information. According to some embodiments, this information may be reviewed, for example by a dealership sales representative or sales manager.

At step 608, an odometer reading or actual mileage may be entered. A vehicle condition rating may also be entered at step 608. According to some embodiments, a condition rating of the vehicle may be a numerical rating (e.g. 1 to 5) or a text description (e.g. “poor,” “fair,” “good,” “excellent”).

At step 610, additional comments or descriptions of the vehicle, condition, or circumstances of sale may be entered. For example, a dealership sales representative or sales manager may enter any information considered relevant to valuation or bidding on the vehicle for which a valuation is requested.

At step 612, according to some embodiment, photos are taken or uploaded of the vehicle for which a valuation is requested. According to some embodiments, photos may be taken by and uploaded from a mobile device operated by a dealership sales representative. Additionally or alternatively, existing accurate photographs may be submitted from a different source. At step 614, according to some embodiments, the completed valuation request may be submitted.

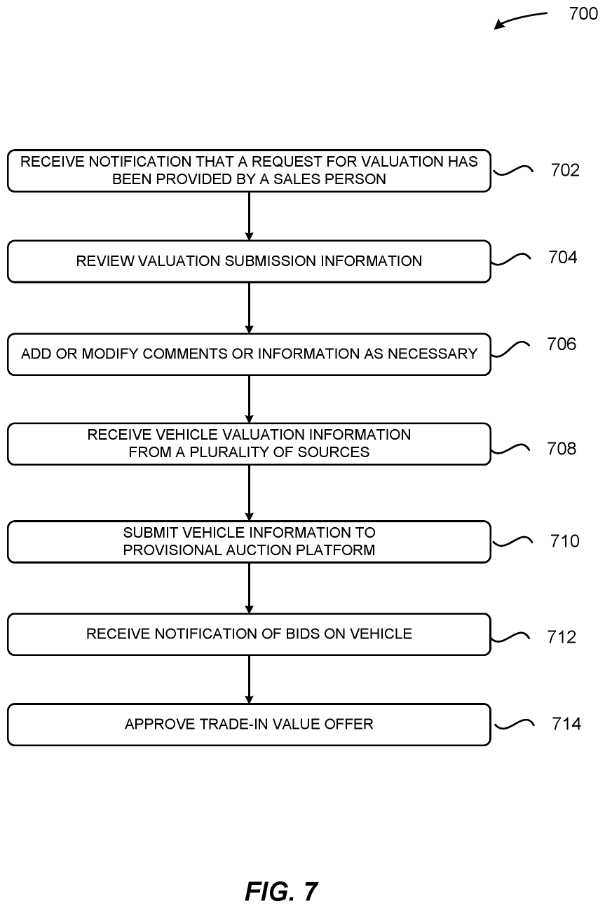

FIG. 7 represents a flowchart for an example workflow of a dealership sales manager according to some embodiments of the disclosure. According to some embodiments, some or all of the steps of flowchart 700 may be carried out by a system like system 100 as described with reference to FIG. 1.

At step 702, a dealership sales manager may receive a notification that a request for valuation has been initiated or completed by a sales representative, for example, according to the flowchart of FIG. 6.

At step 704, according to some embodiments, the dealership sales manager may review the valuation submission information. At step 706, according to some embodiments, the dealership sales manager may add, remove, or otherwise modify information of the valuation submission, for example to improve accuracy or relevance.

At step 708, the dealership sales manager may receive vehicle valuation information from a plurality of platforms, as discussed in further detail herein.

At step 710, according to some embodiments, the dealership sales manager may submit the vehicle information of the valuation submission to a provisional auction platform, the real-time vehicle valuation platform 102, or another appropriate service as would be apparent to one having ordinary skill in the art.

A step 712, according to some embodiments, the dealership sales manager may receive a notification of one or more bids on the vehicle for which valuation was requested. According to some embodiments, this information may include a price of a binding or non-binding “winning” bid of a provisional vehicle auction.

At step 714, the dealership sales manager may approve a trade-in value offer to be made to a customer. The dealership sales manager, according to some embodiments, may then communicate that information to the dealership sales representative responsible for the potential deal.

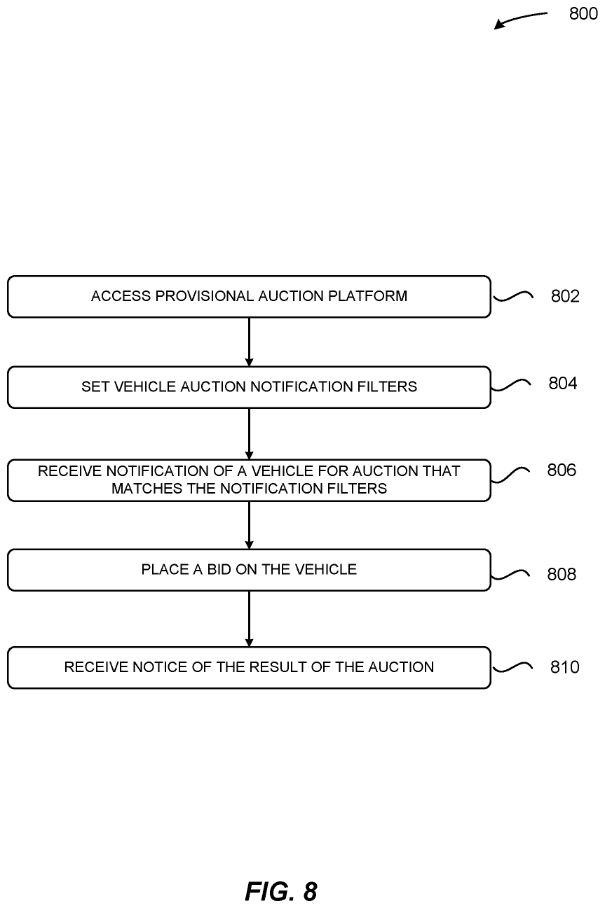

FIG. 8 represents a flowchart for an example workflow of a vehicle dealer according to some embodiments of the disclosure. According to some embodiments, some or all of the steps of flowchart 800 may be carried out by a system like system 100 as described with reference to FIG. 1.

At step 802, the dealer may access a provisional auction platform in order to access the various functions facilitated by the platform. At step 804, according to some embodiments, a vehicle dealer may set one or more vehicle auction notification filters. According to some embodiments, dealers or other users may set notification filters by make and model of vehicle, one or more model year ranges, a vehicle mileage range, a vehicle transmission type, one or more vehicle colors, one or more vehicle body styles (e.g. sedan, coupe, convertible, etc.), condition ratings, title status, and other appropriate vehicle attributes as would be apparent to one having ordinary skill in the art. According to some embodiments, various types of notifications may be requested—for example, SMS/mobile message, email, smartphone push notifications, and any other appropriate notifications as would be apparent to one having ordinary skill in the art.

At step 806, the vehicle dealer may receive one or more notifications that one or more vehicles match the notification filter/preferences. At step 808, after reviewing the specifics of a vehicle matching a notification filter, the vehicle dealer may place a bid on the vehicle. According to some embodiments, as in the case of a provisional short-term (e.g. 15-minute) auto auction, this bid may become binding should it prove to be the winning auction bid. At step 810, the vehicle dealer may receive a notification informing the vehicle dealer of the results of the bid and/or auction.

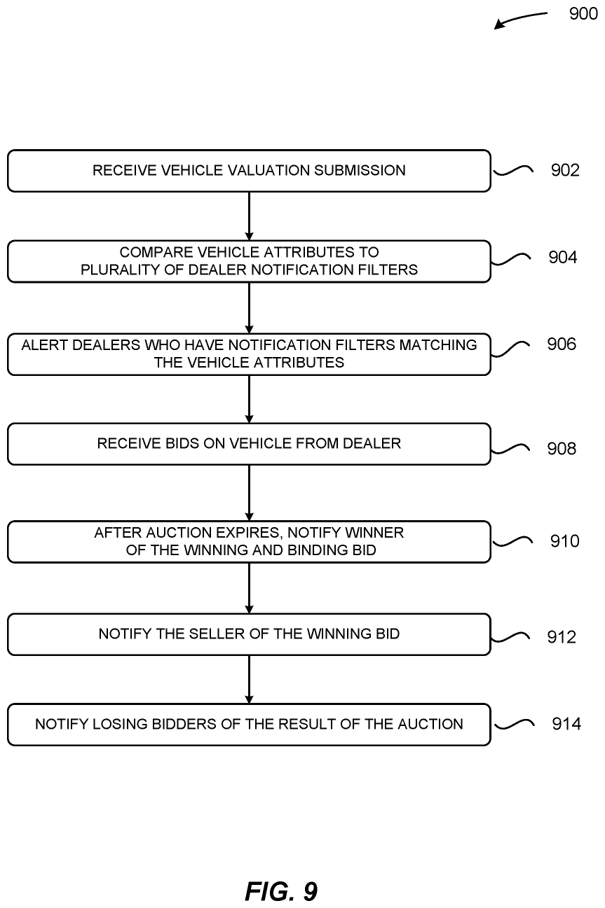

FIG. 9 represents a flowchart for an example workflow on a dealer notification function according to some embodiments of the disclosure. According to some embodiments, some or all of the steps of flowchart 900 may be carried out by a system like system 100 as described with reference to FIG. 1.

At step 902, the notification module may receive a vehicle valuation submission—for example from a dealership sales representative or dealership sales manager as described in detail herein.

At step 904, according to some embodiments, vehicle attributes are compared to notification filters/preferences of a plurality of vehicle dealers. Where the vehicle matches a dealer notification filter or preference, according to some embodiments, the dealer or dealers may be notified at step 906. The form of notification may also be subject to the dealer filters/preferences.

At step 908, bids are received from one or more vehicle dealers. At step 910, after the expiration of an auction, according to some embodiments a winning bidder may be notified of winning the bid for the vehicle and whether the bid is binding, and if it is binding, for how long.

At step 912, according to some embodiments, the seller (e.g. the dealership sales manager or sales representative associated with the valuation submission) is notified of the winning bid. Finally, at step 914, according to some embodiments, losing bidders may be notified electronically of the results of the vehicle provisional auction. According to some embodiments, if there is no winning bid (e.g., an auction reserve is not met), the seller may be notified about the highest bid received, including contact information for the highest bidder.

None of the descriptions in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method comprising:
capturing an image of a vehicle identification number “VIN” of a vehicle;
accessing, at least in part using the VIN of the vehicle, original vehicle information associated with the vehicle;
receiving condition information associated with the vehicle;
creating a vehicle profile, the vehicle profile comprising:
the vehicle's VIN,
at least a portion of the original information associated with the vehicle, and at least a portion of the condition information associated with the vehicle;
transmitting the vehicle profile to a provisional auction platform; and
receiving, from the provisional auction platform, at least one provisional bid for purchase of the vehicle.

2. The method of claim 1, wherein at least one of the at least one provisional bids is binding on a bidder for a period of time.

3. The method of claim 1, wherein the original vehicle information associated with the vehicle comprises information listed on the original window sales sticker of the vehicle.

4. The method of claim 1, wherein the provisional auction platform, at least in part, aggregates estimates of the value of the vehicle received from a plurality of third-party vehicle valuation platforms.

5. The method of claim 1, further comprising:
transmitting the vehicle profile to a plurality of vehicle valuation platforms;
receiving, from the plurality of vehicle valuation platforms, a plurality of estimated values of the vehicle.

6. The method of claim 5, further comprising calculating an aggregated estimated value for the vehicle at least in part by aggregating the received plurality of estimated values of the vehicle.

7. The method of claim 1, further comprising transmitting an auction notification to a plurality of vehicle dealers.

8. The method of claim 1, wherein the condition information associated with the vehicle comprises one or more recent photographs of the vehicle.

9. The method of claim 1, wherein the condition information associated with the vehicle comprises a condition rating of the vehicle.

10. The method of claim 1, wherein the condition information associated with the vehicle includes an odometer value of the vehicle.

11. An automobile pricing system comprising:
a processor;
a VIN scanning device for capturing a VIN of a vehicle;
a memory configured to store instructions that, when executed by the processor, cause the processor to:
receive, from the VIN scanning device, a digital representation of the VIN of the vehicle;
access, at least in part using the VIN of the vehicle, original vehicle information associated with the vehicle;
receive condition information associated with the vehicle;
create a vehicle profile, the vehicle profile comprising:
the vehicle's VIN,
at least a portion of the original information associated with the vehicle, and
at least a portion of the condition information associated with the vehicle;
transmit the vehicle profile to a provisional auction platform; and
receive, from the provisional auction platform, at least one provisional bid for purchase of the vehicle.

12. The system of claim 11, wherein the VIN scanning device comprises a smartphone executing a mobile application programmed for:
capturing an image of a vehicle's VIN; and
generating the digital representation of the vehicle's VIN.

13. The system of claim 11, wherein at least one of the at least one provisional bids is binding on a bidder for a period of time.

14. The system of claim 11, wherein the original vehicle information associated with the vehicle comprises information listed on the original window sales sticker of the vehicle.

15. The system of claim 1, further comprising transmitting an auction notification to a plurality of vehicle dealers.

16. The system of claim 11, wherein the condition information associated with the vehicle comprises one or more recent photographs of the vehicle.

17. The system of claim 11, wherein the condition information associated with the vehicle comprises a condition rating of the vehicle.

18. The system of claim 11, wherein the condition information associated with the vehicle comprises an odometer value of the vehicle.

19. One or more computer-readable media storing instructions that, when executed by one or more computer processors of a computing system, cause the computing system to:
capture an image of a vehicle identification number “VIN” of a vehicle;
access, at least in part using the VIN of the vehicle, original vehicle information associated with the vehicle;
receive condition information associated with the vehicle;
create a vehicle profile, the vehicle profile comprising:
the vehicle's VIN,
at least a portion of the original information associated with the vehicle, and at least a portion of the condition information associated with the vehicle;
transmit the vehicle profile to a provisional auction platform; and
receive, from the provisional auction platform, at least one provisional bid for purchase of the vehicle.

20. The computer-readable media of claim 19, wherein the original vehicle information associated with the vehicle comprises information listed on the original window sales sticker of the vehicle.

21. The computer-readable media of claim 19, wherein the condition information associated with the vehicle comprises at least one selected from:
one or more recent photographs of the vehicle,
a condition rating of the vehicle, and
an odometer value of the vehicle.

22. The computer-readable media of claim 19, wherein the instructions further cause the computing system to:
transmit the vehicle profile to a plurality of vehicle valuation platforms;
receive, from the plurality of vehicle valuation platforms, a plurality of estimated values of the vehicle; and
calculate an aggregated estimated value for the vehicle at least in part by aggregating the received plurality of estimated values of the vehicle.
